(19) United States
(12) Patent Application Publication
(10) Pub. No.: US 2015/0178368 A1
(43) Pub. Date: Jun. 25, 2015

(54) System and Method of Observational Suggestions from Event Relationships

(71) Applicant: Honeywell Intrnational Inc., Morristown, NJ (US)

(72) Inventors: Charles Cameron BRACKETT, Pewaukee, WI (US); Michael R. Harkavy, Hartland, WI (US); Bruce W. Schellinger, West Bend, WI (US)

(73) Assignee: Honeywell Intrnational Inc., Morristown, NJ (US)

(21) Appl. No.: 14/134,409

(22) Filed: Dec. 19, 2013

(51) Int. Cl. G06F 17/30; H04L 29/08

(52) U.S. Cl. CPC G06F 17/30595; H04L 67/10

(57) ABSTRACT

A network has a plurality of user accounts and a network enabled analysis system, which can receive selected information from a first user. A pattern can be established based on the received information, and responsive thereto a comparable pattern can be sought. A data base of patterns can be provided to which the established pattern can be compared using pattern recognition techniques. In one aspect, a processed pattern can be generated. The processed pattern can be compared to patterns of selected information received from other users in the network. In response to finding a comparable pattern, feedback can be provided to the first user.

### FIELD

The application pertains to systems and methods of providing feedback relative to predetermined events. More particularly, the application pertains to finding relationships among events and to providing a user with possible suggestions as to proceeding based on the experiences of other users.

### BACKGROUND

On-line social networks have become very popular vehicles for many individuals to easily communicate information to one another. They provide environments which enable users to connect to and communicate with other users. Examples of such networks include Facebook and LinkedIn.

Social networks such as Facebook and LinkedIn, try to utilize an individual's contacts to propose new links to other individuals. In such systems, the goal is to connect network users. Such connections reflect a single dimension of who knows who to suggest a user might know someone.

It would be useful to move beyond existing types of systems and be able to associate one or more patterns of useful information that originate with a user with similar patterns that originate with other users in the community.

### BRIEF DESCRIPTION OF THE DRAWINGS

FIG. 1 illustrates a diagram of a system in accordance herewith; and

FIG. 2 illustrates aspects of a method which could be implemented by the system of FIG. 1.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In embodiments hereof, relationships among various events a user has experienced can be found, then, other users who have experienced similar event patterns, can be found and possible observations of interest can be provided to the user.

In one aspect, event categories, event types and events can be established to form a plan. Table 1, attached hereto, illustrates an exemplary plan having several categories of events, event types and events in connection with a diagnosis of Type 2 diabetes. Other event categories, event types or events can be defined and come within the spirit and scope hereof.

Event types have specific factual events associated with them. For example, if the category is exercise, as in Table 1, event types can include walking running biking or the like. Events can include durations and, or types of exercise.

The observed or recognized events can be processed, in accordance herewith, to form a characteristic pattern. That pattern can be processed, with respect to pre-established patterns associated with the event type. Other users of the network can be solicited for patterns similar to the processed pattern which would support a conclusion of a specific event, such as a particular disease, or a particular type of bird or flying object. That feedback can be forwarded to the original user for consideration.

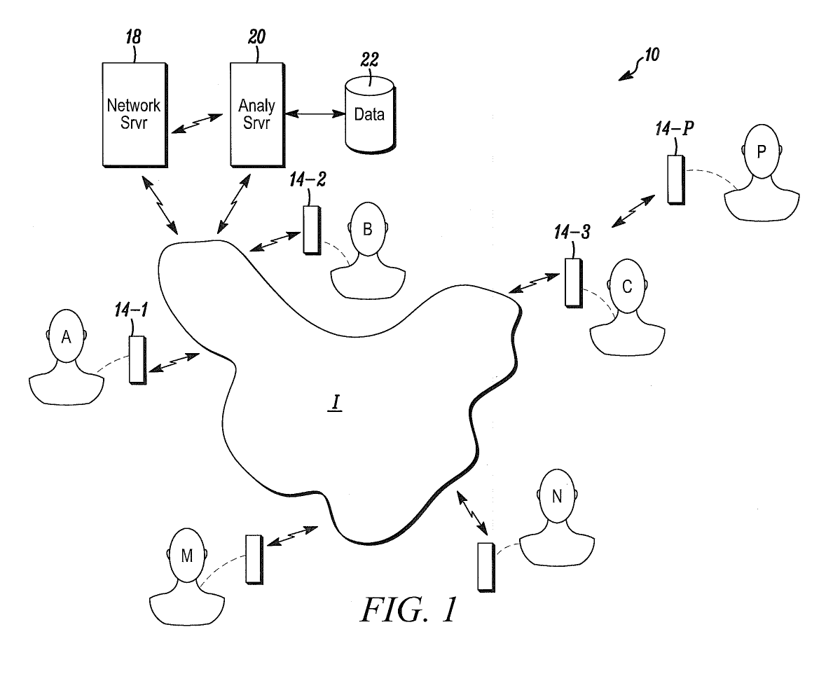

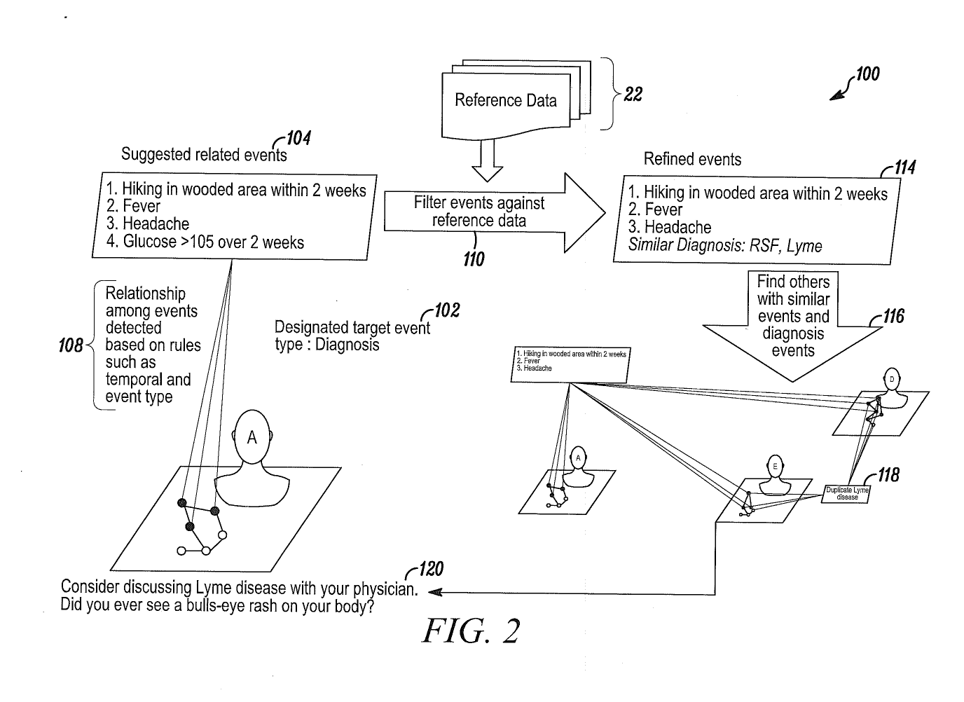

FIGS. 1, 2 illustrate additional aspects of a system and method of the type noted above. FIG. 1 illustrates an exemplary computer based communications network 10 in accordance herewith.

The network 10 can be used simultaneously by a plurality of users, individuals A, B, . . . P who access the network 10 via respective internet enabled, preferably wireless, communication devices such as 14-1, -2, -3, . . . -P. The devices 14-i can be implemented as smart phones, tablet computers, laptop computers or the like all without limitation.

The devices 14-i communicate via a computer based network such as the Internet I with one or more network implementing servers 18 as would be understood by those of skill in the art. One or more analysis servers 20 are coupled directly, or via the Internet I to the network servers 18. A data base 22 which can include pluralities of pre-stored patterns, as discussed below, is coupled to the analysis server 20. It will be understood that the specific operational details of such social networks, except as described herein, are not limitations hereof.

FIG. 2 illustrates a diagnostic process that a person, or user, such as user A, can carry out to obtain information as to a current condition. An exemplary platform which could be implemented by the server 18 can provide institutions such as health care providers, professional service corporations, and payors, such as insurance companies, with the ability to optimize the healthcare management large of populations by providing the families with actionable data. The below described process is a family centric solution that allows each family member to track any event (e.g. headache, BP, meal, run, dr. visit, fever, etc.) about their life.

The collected data is actionable. Exemplary system 10 enables an institution to create a program which addresses a set of event types (for example, a. Wellness Program: Exercise, Diet, BP, Weight) to help improve the health of their respective population. For the user, system 10 can provide value outside of the programs by enabling them to discover things about themselves.

FIG. 2 illustrates aspects of a process 100 wherein the designated Target Event Type is: Diagnosis as at 102. In exemplary process 100 a user A has presented a group of events, as at 104 associated with an out of doors activity.

The events 104 are factual statements that can, via system 10, be reported to server 18. Servers 18, 20 can process inputs from person, or user, A to attempt to find relationships among the events reported by person A as at 108.

The relationship, or pattern, as at 108 can be compared to and/or filtered, as at 110 using pre-store reference information or patterns from data base 22 to produce a set of processed or refined events as at 114. Possible relationships can then be found, as at 116, between the refined events 114 and either or both of pre-stored user related information from data base 22 or real time feedback from users such as users D, E.

Where relationships are found, in this case leading to pre-existing diagnosis of lyme disease, presented by users D, E, as at 118, that information can be forwarded to user A as at 120. It will be understood that embodiments hereof can be implemented incorporating social networks. However, such networks are exemplary only and not limitations of the present system and method.

In summary, unlike social networks, embodiments hereof are not trying to connect people, but to find patterns among people who are users of the network to help narrow relationships among events to present possible observations relevant to a user's interest. A pattern of interest can be represented as a group of event types and events. An event is something that can actually occur, an event instance, but could be anything.

The exemplary process described above relates to the fact that Person A has experienced a suite of events and is not feeling well. Person A can choose to learn more about his/her condition by trying to have the system 10 suggest possible diagnosis event types based on reports of other people, or users, who experienced similar events. This suggests that first of all the events can be related, then matched to other people that have or had similar events with an associated diagnosis event type which could then be forwarded to Person A.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

TABLE 1
PLAN
Newly Diagnosed Type 2 Diabetes

| | | | | | | | Start | Stop | |
|---|---|---|---|---|---|---|---|---|---|
| Event | | | Quan- | | Explicit | | Date/ | Date/ | Com- |
| Category | Event Type | Event | tity | Interval | Time | Duration | Time | Time | ment |
| Biometrics | Glucose | Glucose | | Morning | | Indefinite | Day 0 | | |
| | Weight | Weight | | Weekly | | Indefinite | Day 0 | | |
| | Blood Pressure | Blood Pressure | | Unscheduled | | Indefinite | Day 0 | | |
| Exercise | Walking | 30 minutes Walking | | 3X/week | | Indefinite | Week 4, Sunday | | |
| | Running | 30 minutes Running | | 3X/week | | Indefinite | Week 4, Sunday | | |
| | Biking | 30 Minutes Biking | | 3X/week | | Indefinite | Week 4, Sunday | | |
| | Strength Training | 30 Minutes Strength Training | | 3X/week | | Indefinite | Week 4, Sunday | | |
| | Other | 30 Minutes Other Exercise | | 3X/week | | Indefinite | Week 4, Sunday | | |
| Diet | Meal | Breakfast | | Once per day | | Indefinite | Day 0 | | |
| | | Lunch | | Once per day | | Indefinite | Day 0 | | |
| | | Dinner | | Once per day | | Indefinite | Day 0 | | |
| | Snack | Morning Snack | | Once per day | | Indefinite | Day 0 | | |
| | | Afternoon Snack | | Once per day | | Indefinite | Day 0 | | |
| Medications | Metformin | 500 mg Metformin | | Twice per day | | Indefinite | Day 0 | | |
| Appointment | Physician | <Physician Name> | | | | | | | |
| | Diabetes Educator | <EducatorName> | | | | | | | |
| | Group Class | Class A | | | 5:30 pm | 1 Time | Week 1, Thursday | | |
| | | Class B | | | 5:30 pm | 1 Time | Week 2, Thursday | | |
| | | Class C | | | 5:30 pm | 1 Time | Week 3, Thursday | | |
| Labs | A1C | A1C | | Unscheduled | | | | | |
| | Fasting Glucose | Fasting Glucose | | Unscheduled | | | | | |
| | Glucose Tolerance | Glucose Tolerance | | Unscheduled | | | | | |
| | LDL | LDL | | Unscheduled | | | | | |
| | HDL | HDL | | Unscheduled | | | | | |
| | Triglycerides | Triglycerides | | Unscheduled | | | | | |
| Dental Care | Brush | Brush | | Twice per day | | Indefinite | Day 0 | | |
| | Floss | Floss | | Twice per day | | Indefinite | Day 0 | | |
| Symptoms | Frequent Urination | Frequent Urnination | | Unscheduled | | | | | |
| | Extreme Thirst | Extreme Thirst | | Unscheduled | | | | | |
| | Extreme Fatigue | Extreme Fatigue | | Unscheduled | | | | | |
| | Blurred Vision | Blurred Vision - One Eye | | Unscheduled | | | | | |
| | | Blurred Vision - Both Eyes | | Unscheduled | | | | | |

1. A method comprising:
providing an electronic communication network;
establishing at least one event type;
receiving information at the network as to a group of events related to the event type;
establishing at least one relationship between the events at the network;
retrieving information as to other groups of events related to the event type using the network;
comparing the at least one relationship to corresponding relationships associated with other groups of events; and
determining the existence of the at least one event type.

2. A method as in claim 1 which includes providing feedback via the network as to the existence of the at least one type of event.

3. A method as in claim 2 which includes at least one of a data base which includes pre-stored information as to groups of events, or groups of events received in real-time.

4. A method as in claim 3 where relationships are stored with respective groups of events, or, relationships are established among events received in real-time from network access points.

5. A method as in claim 4 where event types are selected from a class that includes at least diagnosing a condition, playing a game, or observing a selected activity.

6. A network comprising a plurality of user accounts and a network enabled analysis system, which can receive selected information from a first user, wherein a pattern can be established based on the received information, and responsive thereto a comparable pattern can be sought from other users, and which includes, a data base of patterns to which the established pattern can be compared using pattern recognition techniques, in response to finding a comparable pattern, feedback can be provided to the first user.

7. A network as in claim 6 which includes executable instructions to generate a processed pattern, and wherein the processed pattern can be compared to patterns of selected information received from other users in the network.

8. A network as in claim 7 which includes at least one of a data base which includes pre-stored information as to groups of events, or groups of events received in real-time.

9. A network as in claim 8 where relationships are stored with respective groups of events, or, relationships are established among events received in real-time from network access points.

10. A network comprising:
a computerized communications network;
a network enabled analysis system, coupled to the network, the analysis system can receive selected information from a user and establish a pattern, and responsive thereto, seek a comparable pattern associated with a different user, and in response to finding a comparable pattern, providing feedback to the user.

11. A network as in claim 10 wherein comparable patterns can be obtained from one or more of a pre-established data base, or information received from one or more different users.

12. A network as in claim 10 wherein comparable patterns include condition related information.

13. A network as in claim 12 wherein finding a comparable pattern includes using a predetermined metric to implement finding the comparable pattern.

14. A network as in claim 13 where using a predetermined metric includes using a pattern recognition process to compare the established pattern with a plurality of pre-stored patterns.

15. A network as in claim 11 where the communications network implements an on-line social network which receives information related to a physiological condition from the user and where the analysis system establishes a pattern based thereon, the analysis system seeking a comparable physiological pattern associated with another user, and responsive to finding a comparable pattern, forward feedback as to that comparable pattern to the user.

16. A network as in claim 15 which includes a database of condition related patterns, and the analysis system seeks comparable pre-stored patterns in the database.

17. A network as in claim 15 where users communicate with the social network by using at least one of a smart phone, a tablet computer or a laptop computer.
